(19) United States
(12) Patent Application Publication
(10) Pub. No.: US 2024/0398044 A1
(43) Pub. Date: Dec. 5, 2024

(54) AEROSOL GENERATING SYSTEM

(71) Applicant: KT&G CORPORATION, Daejeon (KR)

(72) Inventors: Byungsung CHO, Gwangmyung-si Gyeonggi-do (KR); Jongsub LEE, Sungnam-si Gyeonggi-do (KR); Sangkyu PARK, Seoul (KR); Wooseok CHUNG, Namyangju-si Gyeonggi-do (KR); Daenam HAN, Seoul (KR)

(73) Assignee: KT&G CORPORATION, Daejeon (KR)

(21) Appl. No.: 18/698,608

(22) PCT Filed: Oct. 14, 2022
(86) PCT No.: PCT/KR2022/015651

§ 371 Date: Apr. 4, 2024

(30) Foreign Application Priority Data
Oct. 20, 2021 (KR) 10-2021-0140321
Feb. 25, 2022 (KR) 10-2022-0025357

(51) Int. Cl. A24F 40/90; A24F 40/20; A24F 40/53

(52) U.S. Cl. CPC A24F 40/90; A24F 40/20; A24F 40/53

(57) ABSTRACT

An aerosol generating system is provided. The aerosol generating system includes an aerosol generating device and a charger, wherein the aerosol generating device includes: a first communication interface; a battery; and a first controller configured to: perform control to charge the battery based on wirelessly receiving a power signal from the charger through the first communication interface; determine a state of the aerosol generating device comprising a locked state or an unlocked state and generate a status signal corresponding to the state of the aerosol generating device; transmit, based on initiation of charging of the battery, the status signal to the charger through the first communication interface; and change the aerosol generating device to the unlocked state based on receiving an unlock signal from the charger through the first communication interface.

### TECHNICAL FIELD

The present disclosure relates to an aerosol generating system.

### BACKGROUND ART

An aerosol generating device is a device that extracts certain components from a medium or a substance by producing an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol generating devices has been conducted.

### DISCLOSURE OF INVENTION

### Technical Problem

It is an objective of the present disclosure to solve the above and other problems.

It is another objective of the present disclosure to provide an aerosol generating system that can lock and unlock an aerosol generating device through wireless charging communication.

It is yet another objective of the present disclosure to provide an aerosol generating system that can clear the shipping mode through wireless charging communication even when an aerosol generating device is in a packaged state.

It is yet another objective of the present disclosure to provide an aerosol generating system that can restrict the use of an aerosol generating device by a third party or a minor who does not have access to the aerosol generating device.

### Solution to Problem

According to one aspect of the subject matter described in this application, an aerosol generating system includes: an aerosol generating device and a charger, wherein the aerosol generating device includes: a first communication interface; a battery; and a first controller configured to: perform control to charge the battery based on wirelessly receiving a power signal from the charger through the first communication interface; determine a state of the aerosol generating device comprising a locked state or an unlocked state and generate a status signal corresponding to the state of the aerosol generating device; transmit, based on initiation of charging of the battery, the status signal to the charger through the first communication interface; and change the aerosol generating device to the unlocked state based on receiving an unlock signal from the charger through the first communication interface.

According to another aspect of the subject matter described in this application, an aerosol generating device includes: a first communication interface configured to communicate with a charger of the aerosol generating device; a battery; and a controller configured to: perform control to charge the battery based on wirelessly receiving a power signal from the charger through the first communication interface; determine a state of the aerosol generating device comprising a locked state or an unlocked state and generate a status signal corresponding to the state of the aerosol generating device; transmit, based on initiation of charging of the battery, the status signal to the charger through the first communication interface; and change the aerosol generating device to the unlocked state based on receiving an unlock signal from the charger through the first communication interface.

### Advantageous Effects of Invention

According to at least one of the embodiments of the present disclosure, an aerosol generating device may be locked and unlocked through wireless charging communication.

According to at least one of the embodiments of the present disclosure, the shipping mode may be cleared through wireless charging communication even when an aerosol generating device is in a packaged state.

According to at least one of the embodiments of the present disclosure, a third party or a minor who does not have access to an aerosol generating device may be restricted from using the aerosol generating device.

The additional scope of applicability of the present disclosure will be apparent from the following detailed description. However, those skilled in the art will appreciate that various modifications and alterations are possible, without departing from the idea and scope of the present disclosure, and therefore it should be understood that the detailed description and specific embodiments, such as the preferred embodiments of the present disclosure, are provided only for illustration.

### BRIEF DESCRIPTION OF DRAWINGS

FIG. 1 is a block diagram illustrating an example of an aerosol generating device.

FIGS. 2 to 4 are views referenced to describe examples of an aerosol generating device.

FIGS. 5 to 7 are views referenced to describe examples of a stick.

FIG. 8 is a view illustrating an example of an aerosol generating system.

FIG. 9 is a block diagram illustrating an example of a charger.

FIG. 10 is a flowchart illustrating an example of the operation of an aerosol generating system.

FIGS. 11 and 12 are flowcharts illustrating examples of the operation of a charger.

FIG. 13 is a flowchart illustrating an example of the operation of an aerosol generating system.

### BEST MODE FOR CARRYING OUT THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

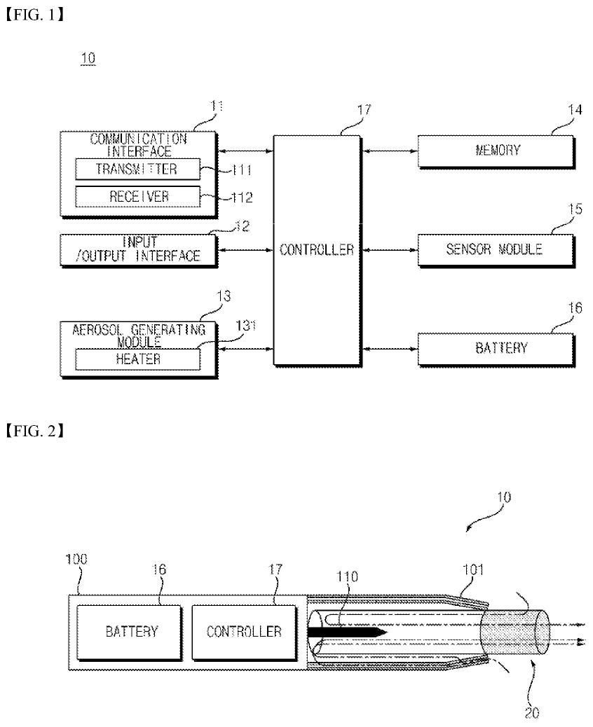

FIG. 1 is a block diagram of an aerosol generating device according to an embodiment of the present disclosure.

Referring to FIG. 1, an aerosol generating device 10 may include a communication interface 11, an input/output interface 12, an aerosol generating module 13, a memory 14, a sensor module 15, a battery 16, and/or a controller 17.

In one embodiment, the aerosol generating device 10 may consist of only a body 100. In this case, components included in the aerosol generating device 10 may be disposed in the body 100. In another embodiment, the aerosol generating device 10 may consist of a cartridge 200, which contains an aerosol generating substance, and a body 100. In this case, components included in the aerosol generating device 10 may be disposed in at least one of the body 100 and the cartridge 200.

The communication interface 11 may include at least one communication module for communication with an external device and/or a network. For example, the communication interface 11 may include a communication module for wired communication such as a Universal Serial Bus (USB). For example, the communication interface 11 may include a communication module for wireless communication such as Wireless Fidelity (Wi-Fi), Bluetooth, Bluetooth Low Energy (BLE), ZigBee, or Near-Field Communication (NFC).

The communication interface 11 may include a transmitter 111 and a receiver 112. The transmitter 111 may transmit a signal to an external device and/or a network. The receiver 112 may receive a signal from an external device and/or a network. The signal transmitted and received through the transmitter 111 and the receiver 112 may be a data signal and/or a power signal.

For example, the data signal may include a status signal transmitted from the aerosol generating device 10 to a charger 70, a lock signal transmitted from the charger 70 to the aerosol generating device 10, an unlock signal transmitted from the charger 70 to the aerosol generating device 10, etc. For example, the power signal may include a power signal transmitted from the charger 70 to the aerosol generating device 10.

The data signal and the power signal transmitted and received through the transmitter 111 and the receiver 112 may be transmitted and received using the same operating frequency band. For example, the transmitter 111 may transmit a data signal using a predetermined operating frequency band. The receiver 112 may receive a data signal and/or a power signal using the same operating frequency band as the transmitter 111. For example, the transmitter 111 and the receiver 112 may transmit and receive a data signal and/or a power signal using a magnetic field produced by a coil.

The data signal and the power signal transmitted and received through the transmitter 111 and the receiver 112 may be transmitted and received using different operating frequency bands. For example, the transmitter 111 may transmit a data signal using a predetermined operating frequency band. The receiver 112 may receive a data signal and/or a power signal using a different operating frequency band from the transmitter 111. For example, the receiver 112 may receive a power signal using a magnetic field produced by a coil and receive a data signal using wireless communication such as NFC, Bluetooth, Bluetooth Low Energy (BLE), or the like, and the transmitter 111 may transmit a data signal using wireless communication such as NFC, Bluetooth, Bluetooth low energy (BLE), or the like.

Meanwhile, the transmitter 111 and the receiver 112 may be one configuration. A transceiver may transceive a signal with an external device and/or a network. In this case, the transceiver may transceive a data signal and a power signal using the same operating frequency band or different operating frequency bands.

The input/output interface 12 may include an input device for receiving a command from a user and/or an output device for outputting information to the user. For example, the input device may include a touch panel, a physical button, a microphone, etc. For example, the output device may include a display device for outputting visual information, such as a display or a light-emitting diode (LED), an audio device for outputting auditory information, such as a speaker or a buzzer, a motor for outputting tactile information, such as a haptic effect, etc.

The input/output interface 12 may transmit data corresponding to a command input by the user through the input device to another component (or other components) of the aerosol generating device 10. The input/output interface 12 may output information corresponding to data received from another component (or other components) of the aerosol generating device 10 through the output device.

The aerosol generating module 13 may generate an aerosol from an aerosol generating substance. Here, the aerosol generating substance may be a substance in a liquid state, a solid state, or a gel state, which can produce an aerosol, or a combination of two or more aerosol generating substances.

In one embodiment, the liquid aerosol generating substance may be a liquid including a tobacco-containing material having a volatile tobacco flavor component. In another embodiment, the liquid aerosol generating substance may be a liquid including a non-tobacco material. For example, the liquid aerosol generating substance may include water, solvents, nicotine, plant extracts, flavorings, flavoring agents, vitamin mixtures, etc.

The solid aerosol generating substance may include a solid material based on a tobacco raw material such as a reconstituted tobacco sheet, shredded tobacco, or granulated tobacco. In addition, the solid aerosol generating substance may include a solid material having a taste control agent and a flavoring material. For example, the taste control agent may include calcium carbonate, sodium bicarbonate, calcium oxide, etc. For example, the flavoring material may include a natural material such as herbal granules, or may include a material such as silica, zeolite, or dextrin, which includes an aroma ingredient.

In addition, the aerosol generating substance may further include an aerosol forming agent such as glycerin or propylene glycol.

The aerosol generating module 13 may include at least one heater 131.

The aerosol generating module 13 may include an electro-resistive heater. For example, the electro-resistive heater may include at least one electrically conductive track. The electro-resistive heater may be heated by the current flowing through the electrically conductive track. Here, the aerosol generating substance may be heated by the heated electro-resistive heater.

The electrically conductive track may include an electro-resistive material. In one example, the electrically conductive track may be formed of a metal material. In another example, the electrically conductive track may be formed of a ceramic material, carbon, a metal alloy, or a composite of a ceramic material and metal.

The electro-resistive heater may include an electrically conductive track that is formed in any of various shapes. For example, the electrically conductive track may have any one of a tubular shape, a plate shape, a needle shape, a rod shape, and a coil shape.

The aerosol generating module 13 may include a heater that uses an induction-heating method, namely, an induction heater. For example, the induction heater may include an electrically conductive coil. The induction heater may generate an alternating magnetic field, which periodically changes in direction, by adjusting the current flowing through the electrically conductive coil. In this case, when the alternating magnetic field is applied to a magnetic body, energy loss may occur in the magnetic body due to eddy current loss and hysteresis loss, and the lost energy may be released as thermal energy. Accordingly, the aerosol generating substance located adjacent to the magnetic body may be heated. Here, an object that generates heat due to the magnetic field may be referred to as a susceptor.

Meanwhile, the aerosol generating module 13 may generate ultrasonic vibrations to thereby produce an aerosol from the aerosol generating substance.

The aerosol generating module 13 may be referred to as a cartomizer, an atomizer, or a vaporizer.

When the aerosol generating device 10 consists of a cartridge 200 containing an aerosol generating substance, and a body 100, the aerosol generating module 13 may be disposed in at least one of the body 100 and the cartridge 200.

The memory 14 may store therein a program for processing and controlling each signal in the controller 17. The memory 14 may store therein data processed and data to be processed by the controller 17.

For example, the memory 14 may store therein applications designed for the purpose of performing various tasks that can be processed by the controller 17. For example, the memory 14 may selectively provide some of the stored applications in response to a request from the controller 17.

For example, the memory 14 may store therein data regarding an operation time of the aerosol generating device 10, the maximum number of puffs, the current number of puffs, the number of charging times of the battery 16, the number of discharging times of the battery 16, at least one temperature profile, a user's inhalation pattern, and charging/discharging. Here, the “puff(s)” may refer to inhalation by a user, and the “inhalation” may refer to the user's act of taking air or other substances into the user's oral cavity, nasal cavity, or lungs through the user's mouth or nose.

For example, the memory 14 may store a preset lock signal (a lock key) and an unlock signal (an unlock key) in relation to locking or unlocking the aerosol generating device 10. The lock key and the unlock key may be keys each having a predetermined value preset by the manufacturer of the aerosol generating device 10.

The memory 14 may include at least one of volatile memory (e.g., dynamic random access memory (DRAM), static random access memory (SRAM), and synchronous dynamic random access memory (SDRAM)), nonvolatile memory (e.g., flash memory), a hard disk drive (HDD), and a solid-state drive (SSD).

The memory 14 may be disposed in at least one of the body 100 and the cartridge 200. The memory 14 may be disposed in each of the body 100 and the cartridge 200. For example, a memory of the body 100 may store information regarding components disposed in the body 100, namely, information regarding the full charge capacity of the battery 16. For example, the memory of the body 100 may store cartridge information received from the cartridge 200 previously or currently coupled to the body 100, and a memory of the cartridge 200 may store cartridge information including cartridge identification information (ID information), a cartridge type, and the like.

The sensor module 15 may include at least one sensor.

For example, the sensor module 15 may include a sensor for sensing a puff (hereinafter referred to as a “puff sensor”). Here, the puff sensor may be implemented as a proximity sensor such as an IR sensor, a pressure sensor, a gyro sensor, an acceleration sensor, a magnetic field sensor, or the like.

For example, the sensor module 15 may include a sensor for sensing a temperature of the heater included in the aerosol generating module 13 and a temperature of the aerosol generating substance (hereinafter referred to as a “temperature sensor”).

In this case, the heater 131 included in the aerosol generating module 13 may serve as the temperature sensor. For example, the electro-resistive material of the heater 131 may be a material having a temperature coefficient of resistance (TCR). The sensor module 15 may measure resistance of the heater 131, which varies according to temperature, to thereby sense the temperature of the heater 131.

For example, when a stick is capable of being inserted into the body 100 of the aerosol generating device 10, the sensor module 15 may include a sensor for sensing insertion of the stick (hereinafter referred to as a “stick detection sensor”).

For example, when the aerosol generating device 10 includes a cartridge 200, the sensor module 15 may include a sensor for sensing mounting/removal (or attachment/detachment) of the cartridge 200 to/from the body 100 and a position of the cartridge 200 (hereinafter referred to as a “cartridge detection sensor”).

In this case, the stick detection sensor and/or the cartridge detection sensor may be implemented as an inductance-based sensor, a capacitance sensor, a resistance sensor, or a Hall IC using a Hall effect. In some embodiments, the cartridge detection sensor may include a connection terminal. The connection terminal may be provided in the body 100. As the cartridge 200 is coupled to the body 100, the connection terminal may be electrically connected to electrodes disposed in the cartridge 200.

For example, the sensor module 15 may include a voltage sensor for sensing a voltage applied to a component (e.g., the battery 16) provided in the aerosol generating device 10 and/or a current sensor for sensing a current.

For example, the sensor module 15 may include at least one sensor for sensing the movement of the aerosol generating device 10 (hereinafter referred to as a “motion sensor”). Here, the motion sensor may be implemented as at least one of a gyro sensor and an acceleration sensor. The motion sensor may be disposed in at least one of the body 100 and the cartridge 200.

The battery 16 may supply power used for the operation of the aerosol generating device 10 under the control of the controller 17. The battery 16 may supply power to other components provided in the aerosol generating device 10. For example, the battery 16 may supply power to the communication module included in the communication interface 11, the output device included in the input/output interface 12, and the heater included in the aerosol generating module 13.

The battery 16 may be a rechargeable battery or a disposable battery. For example, the battery 16 may be a lithium-ion battery or a lithium polymer (Li-polymer) battery, but is not limited thereto. For example, when the battery 16 is rechargeable, a charge rate (C-rate) of the battery 16 may be 10 C, and a discharge rate (C-rate) thereof may be 10 C to 20 C. However, the present disclosure is not limited thereto. In addition, for stable use, the battery 16 may be designed to retain 80% or more of its original capacity at 2,000 full charge and discharge cycles.

The aerosol generating device 10 may further include a battery protection circuit module (PCM), which is a circuit for protecting the battery 16. The battery protection circuit module (PCM) may be disposed adjacent to an upper surface of the battery 16. For example, in order to prevent overcharging and overdischarging of the battery 16, the battery protection circuit module (PCM) may cut off an electrical path to the battery 16 when a short circuit occurs in a circuit connected to the battery 16, when an overvoltage is applied to the battery 16, or when an excessive current flows through the battery 16.

The aerosol generating device 10 may further include a charging terminal to which power supplied from the outside is input. For example, the charging terminal may be provided at one side of the body 100 of the aerosol generating device 10. The aerosol generating device 10 may charge the battery 16 using the power supplied through the charging terminal. In this case, the charging terminal may be configured as a wired terminal for USB communication, a pogo pin, or the like.

The aerosol generating device 10 may wirelessly receive power supplied from the outside through the communication interface 11. The receiver 112 of the communication interface 11 may wirelessly receive a power signal. The receiver 112 may wirelessly receive the power signal from an external charging device. The transmitter 111 and the receiver 112 may include an antenna. The transmitter 111 and the receiver 112 may transmit and receive a signal using one antenna. For example, the antenna may include a coil. The aerosol generating device 10 may wirelessly receive power using an antenna included in a communication module for wireless communication. The aerosol generating device 10 may charge the battery 16 using the wirelessly supplied power through a power signal.

The controller 17 may control the overall operation of the aerosol generating device 10. The controller 17 may be connected to each of the components provided in the aerosol generating device 10. The controller 17 may transmit and/or receive a signal to and/or from each of the components, thereby controlling the overall operation of each of the components.

The controller 17 may include at least one processor. The controller 17 may control the overall operation of the aerosol generating device 10 through the processor included therein. Here, the processor may be a general processor such as a central processing unit (CPU). Alternatively, the processor may be a dedicated device such as an application-specific integrated circuit (ASIC) or any of other hardware-based processors.

The controller 17 may perform any one of a plurality of functions of the aerosol generating device 10. For example, the controller 17 may perform any one of a plurality of functions of the aerosol generating device 10 (e.g., a preheating function, a heating function, a charging function, and a cleaning function) according to the state of each of the components provided in the aerosol generating device 10, a user command received through the input/output interface 12, and the like.

The controller 17 may control the operation of each of the components provided in the aerosol generating device 10 based on data stored in the memory 14. For example, the controller 17 may control such that predetermined power is supplied from the battery 16 to the aerosol generating module 13 for a predetermined time based on data stored in the memory 14 such as the temperature profile and the user's inhalation pattern.

The controller 17 may determine the occurrence or non-occurrence of a puff through the puff sensor included in the sensor module 15. For example, the controller 17 may check a temperature change, a flow change, a pressure change, and a voltage change in the aerosol generating device 10 based on values sensed by the puff sensor. For example, the controller 17 may determine the occurrence or non-occurrence of a puff according to the result of checking based on a value sensed by the puff sensor.

The controller 17 may control the operation of each of the components provided in the aerosol generating device 10 according to the occurrence or non-occurrence of a puff and/or the number of puffs. For example, the controller 17 may control the temperature of the heater 131 to be changed or maintained based on the temperature profile stored in the memory 14.

The controller 17 may control such that the supply of power to the heater 131 is interrupted according to a predetermined condition. For example, the controller 17 may control such that the supply of power to the heater is cut off when a stick is removed, when the cartridge 200 is removed from the body 100, when the number of puffs reaches the predetermined maximum number of puffs, when a puff is not sensed for a predetermined time or longer, or when the remaining capacity of the battery 16 is less than a predetermined value.

The controller 17 may calculate the remaining capacity (hereinafter referred to as the “remaining amount of power”) with respect to the full charge capacity of the battery 16. For example, the controller 17 may calculate the remaining amount of power of the battery 16 based on a value sensed by the voltage sensor and/or the current sensor included in the sensor module 15.

The controller 17 may control such that power is supplied to the heater 131 using at least one of a pulse width modulation (PWM) method and a proportional-integral-differential (PID) method.

For example, the controller 17 may control such that a current pulse having a predetermined frequency and a predetermined duty ratio is supplied to the heater using the PWM method. In this case, the controller 17 may control power supplied to the heater 131 by adjusting the frequency and the duty ratio of the current pulse.

For example, the controller 17 may determine a target temperature to be controlled based on the temperature profile. In this case, the controller 17 may control power supplied to the heater 131 using the PID method, which is a feedback control method using a difference value between the temperature of the heater and the target temperature, a value obtained by integrating the difference value with respect to time, and a value obtained by differentiating the difference value with respect to time.

For example, the controller 17 may control power supplied to the heater 131 based on the temperature profile. The controller 17 may control a length of a heating section for heating the heater 131, the amount of power supplied to the heater 131 in the heating section, and the like. The controller 17 may control power supplied to the heater 131 based on the target temperature of the heater 131.

Although the PWM method and the PID method are described as exemplary methods of controlling the supply of power to the heater 131, the present disclosure is not limited thereto. Other various control methods, such as a proportional-integral (PI) method and a proportional-differential (PD) method, may also be used.

The controller 17 may determine a temperature of the heater 131, and may adjust the amount of power supplied to the heater 131 according to the temperature of the heater 131. For example, the controller 17 may determine the temperature of the heater 131 by checking a resistance value of the heater 131, a current flowing through the heater 131, and/or a voltage applied to the heater 131.

Meanwhile, the controller 17 may control such that power is supplied to the heater 131 according to a predetermined condition. For example, when a cleaning function for cleaning a space into which a stick is inserted is selected according to a command input by the user through the input/output interface 12, the controller 17 may control such that predetermined power is supplied to the heater 131.

FIGS. 2 to 4 are views for explaining an aerosol generating device according to embodiments of the present disclosure.

According to various embodiments of the present disclosure, the aerosol generating device 10 may include a body 100 and/or a cartridge 200.

Referring to FIG. 2, the aerosol generating device 10 according to this embodiment may include a body 100 configured to allow a stick 20 to be inserted into a space defined by a housing 101 thereof.

The stick 20 may be similar to a general combustive cigarette. For example, the stick 20 may be divided into a first part including an aerosol generating substance and a second part including a filter and the like. Alternatively, the second part of the stick 20 may also include an aerosol generating substance. For example, an aerosol generating substance made in the form of granules or capsules may be inserted into the second part.

The entire first part may be inserted into the aerosol generating device 10, and the second part may be exposed to the outside. Alternatively, only a portion of the first part may be inserted into the aerosol generating device 10, or portions of the first part and the second part may be inserted into the aerosol generating device 10. A user may inhale an aerosol while holding the second part in his or her mouth. As outside or external air passes through the first part, an aerosol may be generated, and the generated aerosol may pass through the second part to be delivered to the mouth of the user.

The body 100 may have a structure that allows external air to be introduced therein with the stick 20 inserted. Here, the external air introduced into the body 100 may pass through the stick 20 to flow into the mouth of the user.

A heater may be disposed in the body 100 at a position corresponding to a position at which the stick 20 is inserted into the body 100. Although the heater in FIG. 2 is illustrated as an electrically conductive heater 110 including an electrically conductive track of a needle-shape, the present disclosure is not limited thereto.

The heater may heat an inside and/or outside of the stick 20 by using power supplied from the battery 16. In this case, an aerosol may be generated in the heated stick 20. Here, the user may puff on one end of the stick 20 with his or her mouth to inhale a tobacco-flavored aerosol.

Meanwhile, according to a predetermined condition, the controller 17 may control such that power is supplied to the heater even when the stick 20 is not inserted into the body 100. For example, when a cleaning function for cleaning the space into which the stick 20 is inserted is selected according to a command input by the user through the input/output interface 12, the controller 17 may control predetermined power to be supplied to the heater.

The controller 17 may monitor the number of puffs upon insertion of the stick 20 into the body 10 based on a value sensed by the puff sensor 151.

When the inserted stick 20 is removed from the body 100, the controller 17 may initialize the current number of puffs stored in the memory 14.

Referring to FIG. 3, the aerosol generating device 10 according to this embodiment may include a body 100 that supports a cartridge 200 and the cartridge 200 that contains an aerosol generating substance.

In one embodiment, the cartridge 200 may be configured to be detachably attached to the body 100. In another embodiment, the cartridge 200 may be integrally formed with the body 100. For example, at least a portion of the cartridge 200 may be inserted into an inner space defined by a housing 101 of the body 100, allowing the cartridge 200 to be mounted to the body 100.

The body 100 may have a structure that allows external air to be introduced therein with the cartridge 200 inserted. Here, the external air introduced into the body 100 may pass through the cartridge 200 to flow into the mouth of the user.

The controller 17 may determine mounting/removal of the cartridge 200 to/from the body 100 through the cartridge detection sensor included in the sensor module 15. For example, the cartridge detection sensor may transmit a pulse current through one terminal connected to the cartridge 200. In this case, the cartridge detection sensor may detect connection or disconnection of the cartridge 200 based on whether the pulse current is received through another terminal.

The cartridge 200 may include a heater 210 that heats an aerosol generating substance and/or a storage portion 220 that stores the aerosol generating substance. For example, a liquid delivery element impregnated with (containing) the aerosol generating substance may be disposed in the storage portion 220. An electrically conductive track of the heater 210 may have a structure wound around the liquid delivery element. As the liquid delivery element is heated by the heater 210, an aerosol may be produced. Here, the liquid delivery element may be a wick such as cotton fiber, ceramic fiber, glass fiber, or porous ceramic.

The cartridge 200 may include an insertion space 230 configured to allow a stick 20 to be inserted therein. For example, the cartridge 200 may include an insertion space defined by an inner wall (not shown) extending in a circumferential direction along a direction in which the stick 20 is inserted. Here, an inside of the inner wall may be open vertically to define the insertion space. The stick 20 may be inserted into the insertion space 230 defined by the inner wall.

The insertion space into which the stick 20 is inserted may have a shape corresponding to a shape of a portion of the stick 20 inserted into the insertion space. For example, when the stick 20 has a cylindrical shape, the insertion space may be formed in a cylindrical shape.

When the stick 20 is inserted into the insertion space, an outer circumferential surface of the stick 20 may be surrounded by the inner wall to be in contact with the inner wall.

A portion of the stick 20 may be inserted into the insertion space 230 of the cartridge 200, and the remaining portion may be exposed to the outside.

The user may inhale an aerosol while holding one end of the stick 20 in his or her mouth. An aerosol generated by the heater 210 may pass through the stick 20 to be delivered to the mouth of the user. Here, a material included in the stick 20 may be added to the aerosol while passing through the stick 20, and the material-added aerosol may be inhaled into the mouth of the user through the one end of the stick 20.

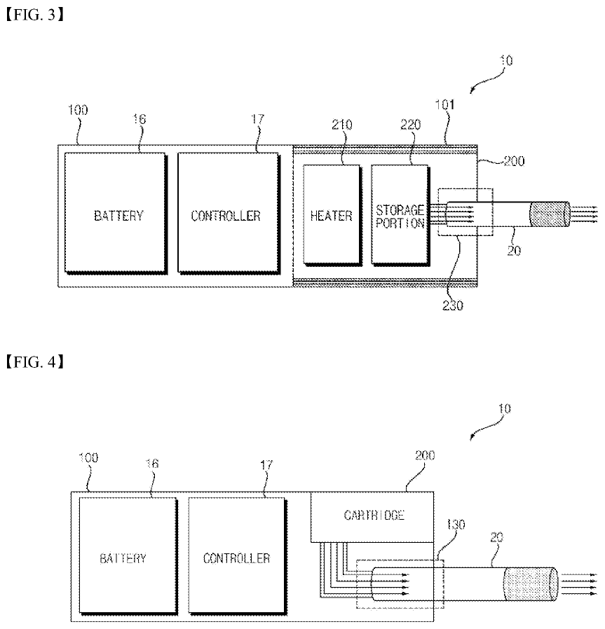

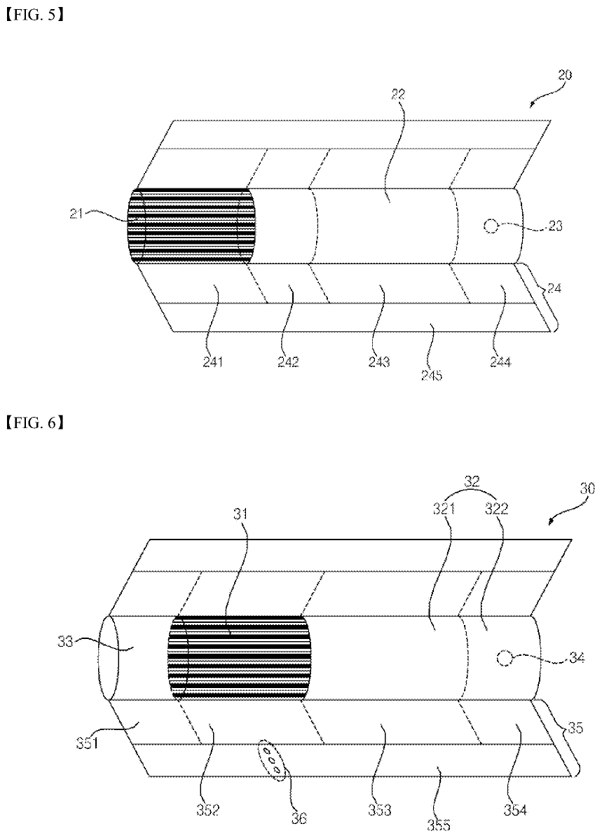

Referring to FIG. 4, the aerosol generating device 10 according to this embodiment may include a body 100 that supports a cartridge 200 and the cartridge 200 that contains an aerosol generating substance. The body 100 may be configured such that a stick 20 is insertable into an insertion space 130.

The aerosol generating device 10 may include a first heater configured to heat the aerosol generating substance stored in the cartridge 200. For example, when a user puff on one end of the stick 20 with his or her mouth, an aerosol generated by the first heater may pass through the stick 20. Here, a flavoring may be added to the aerosol while passing through the stick 20. The flavored aerosol may be inhaled into the mouth of the user through the one end of the stick 20.

In another embodiment, the aerosol generating device 10 may include a first heater configured to heat the aerosol generating substance stored in the cartridge 200 and a second heater configured to heat the stick 20 inserted into the body 100. For example, the aerosol generating device 10 may generate an aerosol by heating the aerosol generating substance stored in the cartridge 200 and the stick 20 through the first heater and the second heater, respectively.

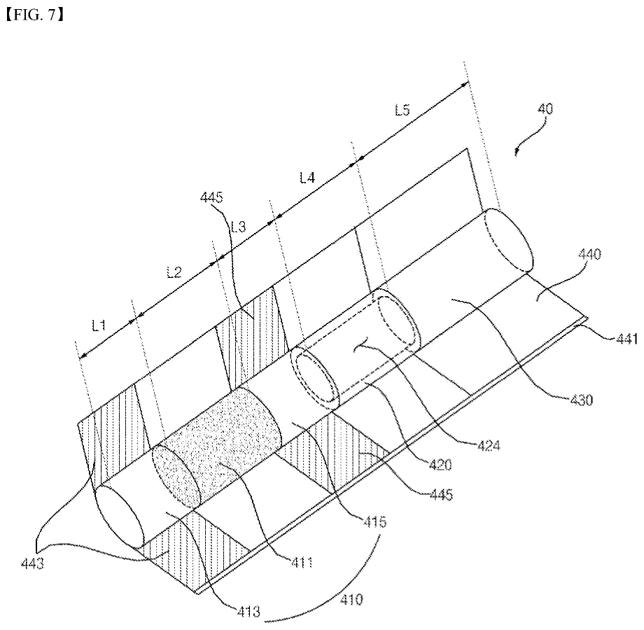

FIGS. 5 to 7 are views for explaining a stick according to embodiments of the present disclosure. Overlapping descriptions in FIGS. 5 to 7 will be omitted.

Referring to FIG. 5, a stick 20 according to this embodiment may include a tobacco rod 21 and a filter rod 22. The first part described above with reference to FIG. 2 may include the tobacco rod 21. The second part described above with reference to FIG. 2 may include the filter rod 22.

The filter rod 22 in FIG. 5 is shown as a single segment but is not limited thereto. In other words, the filter rod 22 may include a plurality of segments. For example, the filter rod 22 may include a first segment for cooling an aerosol and a second segment for filtering a predetermined component included in the aerosol. In addition, when necessary, the filter rod 22 may further include at least one segment performing another function.

A diameter of the stick 20 may be in a range of 5 mm to 9 mm, and a length of the stick 20 may be about 48 mm. However, the present disclosure is not limited thereto. For example, a length of the tobacco rod 21 may be about 12 mm, a length of the first segment of the filter rod 22 may be about 10 mm, a length of the second segment of the filter rod 22 may be about 14 mm, and a length of a third segment of the filter rod 22 may be about 12 mm. However, the present disclosure is not limited thereto.

The stick 20 may be wrapped by at least one wrapper 24. The wrapper 24 may have at least one hole through which external air is introduced or internal gas is discharged. In one example, the stick 20 may be wrapped by one wrapper 24. In another example, the stick 20 may be wrapped by two or more wrappers 24 in an overlapping manner. For example, the tobacco rod 21 may be wrapped by a first wrapper 241. For example, the filter rod 22 may be wrapped by second wrappers 242, 243, and 244. The tobacco rod 21 and the filter rod 22, which are wrapped by the respective wrappers, may be coupled to each other. The entire stick 20 may be rewrapped by a third wrapper 245. When the filter rod 22 consists of a plurality of segments, each of the segments may be wrapped by an individual wrapper (242, 243, 244). In addition, the entire stick 20 in which the segments respectively wrapped by the individual wrappers are coupled to one another may be rewrapped by another wrapper.

The first wrapper 241 and the second wrapper 242 may be made of general filter wrapping paper. For example, the first wrapper 241 and the second wrapper 242 may be porous wrappers or non-porous wrappers. In addition, the first wrapper 241 and the second wrapper 242 may be made of paper and/or an aluminum laminate packaging material with oil resistance.

The third wrapper 243 may be made of hard wrapping paper. For example, a basis weight of the third wrapper 243 may be in a range of 88 g/m² to 96 g/m². For example, a basis weight of the third wrapper 243 may be in a range of 90 g/m² to 94 g/m². In addition, a thickness of the third wrapper 243 may be in a range of 120 μm to 130 μm. For example, the thickness of the third wrapper 243 may be 125 μm.

The fourth wrapper 244 may be made of an oil-resistant hard wrapping paper. For example, a basis weight of the fourth wrapper 244 may be in a range of 88 g/m² to 96 g/m². For example, a basis weight of the fourth wrapper 244 may be in a range of 90 g/m² to 94 g/m². In addition, a thickness of the fourth wrapper 244 may be in a range of 120 μm to 130 μm. For example, the thickness of the fourth wrapper 244 may be 125 μm.

The fifth wrapper 245 may be made of sterile paper (MFW). Here, the sterile paper (MFW) may refer to paper specially designed to have improved tensile strength, water resistance, smoothness, and the like compared to general paper. For example, a basis weight of the fifth wrapper 245 may be in a range of 57 g/m² to 63 g/m². For example, a basis weight of the fifth wrapper 245 may be 60 g/m². In addition, a thickness of the fifth wrapper 245 may be in a range of 64 μm to 70 μm. For example, the thickness of the fifth wrapper 245 may be 67 μm.

A predetermined material may be added into the fifth wrapper 245. Here, an example of the predetermined material may be silicone, but is not limited thereto. For example, silicone may have properties such as heat resistance having little change with temperature, oxidation resistance, resistance to various chemicals, water repellency to water, electrical insulation, etc. However, other than the silicone, any material having the above-described properties may be applied onto or coated on the fifth wrapper 245.

The fifth wrapper 245 may prevent combustion of the stick 20. For example, when the tobacco rod 21 is heated by the heater 110, there may exist a possibility of combustion of the stick 20. In detail, when the temperature rises above the ignition point of any one of the materials included in the tobacco rod 21, the stick 20 may be combustible. However, as the fifth wrapper 245 includes a non-combustible material, the combustion of the stick 20 may be prevented.

In addition, the fifth wrapper 245 may prevent the body 100 from being contaminated by materials generated in the stick 20. Liquid materials may be generated in the stick 20 due to a puff by a user. For example, as an aerosol produced in the stick 20 is cooled by external air, liquids (e.g., moisture, etc.) may be generated. As the stick 20 is wrapped by the fifth wrapper 245, the liquids generated in the stick 20 may be prevented from leaking out of the stick 20.

The tobacco rod 21 may include an aerosol generating substance. For example, the aerosol generating substance may include, but is not limited to, at least one of glycerin, propylene glycol, ethylene glycol, dipropylene glycol, diethylene glycol, triethylene glycol, tetraethylene glycol, and oleyl alcohol. Also, the tobacco rod 21 may contain other additives such as a flavoring agent, a wetting agent, and/or an organic acid. In addition, a flavoring liquid, such as menthol or humectant, may be added to the tobacco rod 21 by being sprayed onto the tobacco rod 21.

The tobacco rod 21 may be manufactured in various ways. For example, the tobacco rod 21 may be formed as a sheet. For example, the tobacco rod 21 may be formed as strands. For example, the tobacco rod 21 may be formed as shredded tobacco obtained by finely cutting a tobacco sheet. For example, the tobacco rod 21 may be surrounded by a heat conductive material. For example, the heat conductive material may be a metal foil such as aluminum foil, but is not limited thereto. For example, the heat conductive material surrounding the tobacco rod 21 may evenly distribute heat transferred to the tobacco rod 21 to thereby increase conductivity of the heat applied to the tobacco rod 21. As a result, the taste of tobacco may be improved. The heat conductive material surrounding the tobacco rod 21 may serve as a susceptor heated by an induction heater. Although not shown in the drawing, the tobacco rod 21 may further include an additional susceptor, in addition to the heat conductive material surrounding an outside thereof.

The filter rod 22 may be a cellulose acetate filter. Moreover, the filter rod 22 is not limited to a particular shape. For example, the filter rod 22 may be a cylinder type rod. For example, the filter rod 22 may be a tube type rod including a hollow therein. For example, the filter rod 22 may be a recess type rod. When the filter rod 22 consists of a plurality of segments, at least one of the plurality of segments may have a different shape from the others.

The first segment of the filter rod 22 may be a cellulose acetate filter. For example, the first segment may be a tube-shaped structure including a hollow therein. The first segment may prevent an inner material of the tobacco rod 21 from being pushed back upon insertion of the heater 110, and may provide the effect of cooling an aerosol. A diameter of the hollow included in the first segment may be appropriately determined or selected in a range of 2 mm to 4.5 mm, but is not limited thereto.

A length of the first segment may be appropriately determined in a range of 4 mm to 30 mm, but is not limited thereto. For example, the length of the first segment may be 10 mm, but is not limited thereto.

The second segment of the filter rod 22 cools an aerosol generated when the heater 110 heats the tobacco rod 21. Thus, the user may inhale an aerosol cooled to an appropriate temperature.

A length or diameter of the second segment may be variously determined according to the shape of the stick 20. For example, the length of the second segment may be appropriately selected in a range of 7 mm to 20 mm. More preferably, the length of the second segment may be about 14 mm, but is not limited thereto.

The second segment may be made by weaving polymer fibers. In this case, a flavoring liquid may be applied to a fiber made of polymers. Alternatively, the second segment may be made by weaving a separate fiber coated with a flavoring liquid and a fiber made of polymers together. Alternatively, the second segment may be made of a crimped polymer sheet.

For example, a polymer may be made of a material selected from the group consisting of polyethylene (PE), polypropylene (PP), polyvinyl chloride (PVC), polyethylene terephthalate (PET), polylactic acid (PLA), cellulose acetate (CA), and aluminum foil.

As the second segment is made of the woven polymer fiber or the crimped polymer sheet, the second segment may include a single channel or a plurality of channels extending in a longitudinal direction. Here, the “channel” may refer to a passage through which gas (e.g., air or aerosol) passes.

For example, the second segment made of a crimped polymer sheet may be made from a material having a thickness between 5 μm and 300 μm, namely, between 10 μm and 250 μm. Also, a total surface area of the second segment may be between 300 mm²/mm and 1000 mm²/mm. In addition, an aerosol cooling element may be made from a material with a specific surface area between 10 mm²/mg and 100 mm²/mg.

Meanwhile, the second segment may include a thread containing a volatile flavor component. Here, the volatile flavor component may be menthol, but is not limited thereto. For example, the thread may be filled with a sufficient amount of menthol to provide at least 1.5 mg of menthol to the second segment.

The third segment of the filter rod 22 may be a cellulose acetate filter. A length of the third segment may be appropriately selected in a range of 4 mm to 20 mm. For example, the length of the third segment may be about 12 mm, but is not limited thereto.

The filter rod 22 may be manufactured to generate flavor. In one example, a flavoring liquid may be sprayed onto the filter rod 22. In another example, a separate fiber coated with a flavoring liquid may be inserted into the filter rod 22.

In addition, the filter rod 22 may include at least one capsule 23. Here, the capsule 23 may perform a function of generating flavor. The capsule 23 may also perform a function of generating an aerosol. For example, the capsule 23 may have a structure in which a liquid containing a flavoring material is wrapped with a film. The capsule 23 may have a spherical or cylindrical shape, but is not limited thereto.

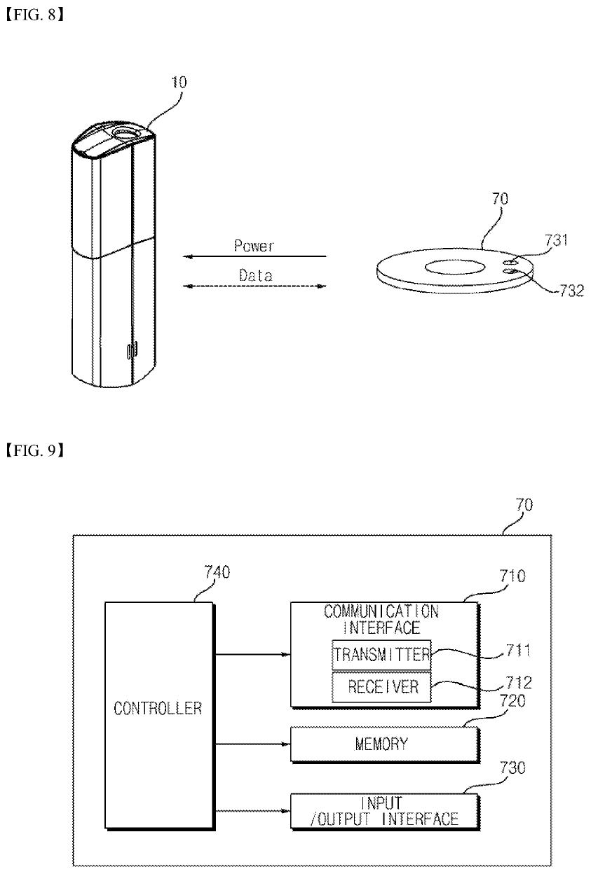

Referring to FIG. 6, a stick 30 according to this embodiment may further include a front-end plug 33. The front-end plug 33 is disposed on one side opposite a filter rod 32 with respect to a tobacco rod 31. The front-end plug 33 may prevent the tobacco rod 31 from being separated to the outside. The front-end plug 33 may prevent a liquefied aerosol from flowing into the aerosol generating device 10 from the tobacco rod 31 while smoking.

The filter rod 32 may include a first segment 321 and a second segment 322. The first segment 321 may correspond to the first segment of the filter rod 22 of FIG. 5. The second segment 322 may correspond to the third segment of the filter rod 22 of FIG. 5.

A diameter and an overall length of the stick 30 may correspond to the diameter and the overall length of the stick 20 of FIG. 5. For example, a length of the front-end plug 33 may be about 7 mm, a length of the tobacco rod 31 may be about 15 mm, a length of the first segment 321 may be about 12 mm, and a length of the second segment 322 may be about 14 mm. However, the present disclosure is not limited thereto.

The stick 30 may be wrapped by at least one wrapper 35. The wrapper 35 may have at least one hole through which external air is introduced or internal gas is discharged. For example, the front-end plug 33 may be wrapped by a first wrapper 351, the tobacco rod 31 may be wrapped by a second wrapper 352, the first segment 321 may be wrapped by a third wrapper 353, and the second segment 322 may be wrapped by a fourth wrapper 354. Then, the entire stick 30 may be rewrapped by a fifth wrapper 355.

In addition, the fifth wrapper 355 may have at least one perforation 36. For example, the perforation 36 may be formed in an area surrounding the tobacco rod 31, but is not limited thereto. For example, the perforation 36 may serve to transfer heat generated by the heater 210 of FIG. 3 to an inside of the tobacco rod 31.

Also, the second segment 322 may include at least one capsule 34. Here, the capsule 34 may perform a function of generating flavor. The capsule 34 may also perform a function of generating an aerosol. For example, the capsule 34 may have a structure in which a liquid containing a flavoring material is wrapped with a film. The capsule 34 may have a spherical or cylindrical shape, but is not limited thereto.

The first wrapper 351 may be made by coupling a metal foil, such as aluminum foil, to general filter wrapping paper. For example, a total thickness of the first wrapper 351 may be in a range of 45 μm to 55 μm. For example, the total thickness of the first wrapper 351 may be 50.3 μm. In addition, a thickness of the metal foil of the first wrapper 351 may be in a range of 6 μm to 7 μm. For example, the thickness of the metal foil of the first wrapper 351 may be 6.3 μm. In addition, a basis weight of the first wrapper 351 may be in a range of 50 g/m² to 55 g/m². For example, the basis weight of the first wrapper 351 may be 53 g/m².

The second wrapper 352 and the third wrapper 353 may be made of general filter wrapping paper. For example, the second wrapper 352 and the third wrapper 353 may be porous wrappers or non-porous wrappers.

For example, porosity of the second wrapper 352 may be 35000 CU, but is not limited thereto. In addition, a thickness of the second wrapper 352 may be in a range of 70 μm to 80 μm. For example, the thickness of the second wrapper 352 may be 78 μm. In addition, a basis weight of the second wrapper 352 may be in a range of 20 g/m² to 25 g/m². For example, the basis weight of the second wrapper 352 may be 23.5 g/m².

For example, porosity of the third wrapper 353 may be 24000 CU, but is not limited thereto. In addition, a thickness of the third wrapper 353 may be in a range of 60 μm to 70 μm. For example, the thickness of the third wrapper 353 may be 68 μm. In addition, a basis weight of the third wrapper 353 may be in a range of 20 g/m² to 25 g/m². For example, the basis weight of the third wrapper 353 may be 21 g/m².

The fourth wrapper 354 may be made of PLA laminated paper. Here, the PLA laminated paper may refer to a three-layer paper consisting of a paper layer, a PLA layer, and a paper layer. For example, a thickness of the fourth wrapper 354 may be in a range of 100 μm to 120 μm. For example, the thickness of the fourth wrapper 354 may be 110 μm. In addition, a basis weight of the fourth wrapper 354 may be in a range of 80 g/m² to 100 g/m². For example, the basis weight of the fourth wrapper 354 may be 88 g/m².

The fifth wrapper 355 may be made of sterile paper (MFW). Here, the sterile paper (MFW) may refer to paper specially designed to have improved tensile strength, water resistance, smoothness, and the like compared to general paper. For example, a basis weight of the fifth wrapper 355 may be in a range of 57 g/m² to 63 g/m². For example, the basis weight of the fifth wrapper 355 may be 60 g/m². In addition, a thickness of the fifth wrapper 355 may be in a range of 64 μm to 70 μm. For example, the thickness of the fifth wrapper 355 may be 67 μm.

A predetermined material may be added into the fifth wrapper 355. Here, an example of the predetermined material may be silicone, but is not limited thereto. For example, silicone has properties such as heat resistance with little change with temperature, oxidation resistance, resistance to various chemicals, water repellency to water, electrical insulation, etc. However, other than the silicone, any material having the above-described properties may be applied (or coated) onto the fifth wrapper 355.

The front-end plug 33 may be made of cellulose acetate. In one example, the front-end plug 33 may be made by adding a plasticizer (e.g., triacetin) to cellulose acetate tow. A mono denier of a filament constituting the cellulose acetate tow may be in a range of 1.0 to 10.0. For example, the mono denier of the filament constituting the cellulose acetate tow may be in a range of 4.0 to 6.0. For example, a mono denier of a filament of the front-end plug 33 may be 5.0. In addition, a cross section of the filament of the front-end plug 33 may be a Y-shape. A total denier of the front-end plug 33 may be in a range of 20000 to 30000. For example, the total denier of the front-end plug 33 may be in a range of 25000 to 30000. For example, the total denier of the front-end plug 33 may be 28000.

In addition, when necessary, the front-end plug 33 may include at least one channel. A shape of a cross section of the channel of the front-end plug 330 may be formed in various ways.

The tobacco rod 31 may correspond to the tobacco rod 21 described above with reference to FIG. 5. Therefore, a detailed description of the tobacco rod 31 will be omitted.

The first segment 321 may be made of cellulose acetate. For example, the first segment may be a tube-shaped structure including a hollow therein. The first segment 321 may be made by adding a plasticizer (e.g., triacetin) to cellulose acetate tow. For example, a mono denier and a total denier of the first segment 321 may be the same as the mono denier and the total denier of the front-end plug 33.

The second segment 322 may be made of cellulose acetate. A mono denier of a filament of the second segment 322 may be in a range of 1.0 to 10.0. For example, the mono denier of the filament of the second segment 322 may be in a range of 8.0 to 10.0. For example, the mono denier of the filament of the second segment 322 may be 9.0. In addition, a cross section of the filament of the second segment 322 may be a Y-shape. A total denier of the second segment 322 may be in a range of 20000 to 30000. For example, the total denier of the second segment 322 may be 25000.

Referring to FIG. 7, a stick 40 may include a medium portion 410. The stick 40 may include a cooling portion 420. The stick 40 may include a filter portion 430. The cooling portion 420 may be disposed between the medium portion 410 and the filter portion 430. The stick 40 may include a wrapper 440. The wrapper 440 may wrap the medium portion 410. The wrapper 440 may wrap the cooling portion 420. The wrapper 440 may wrap the filter portion 430. The stick 40 may have a cylindrical shape.

The medium portion 410 may include a medium 411. The medium portion 410 may include a first medium cover 413. The medium portion 410 may include a second medium cover 415. The medium 411 may be disposed between the first medium cover 413 and the second medium cover 415. The first medium cover 413 may be disposed at one end of the stick 40. The medium portion 410 may have a length of 24 mm.

The medium 411 may contain a multicomponent substance. The substance contained in the medium may be a multicomponent flavoring substance. The medium 411 may be composed of a plurality of granules. Each of the plurality of granules may have a size of 0.4 mm to 1.12 mm. The granules may account for approximately 70% of the volume of the medium 411. A length L2 of the medium 411 may be 10 mm. The first medium cover 413 may be made of an acetate material. The second medium cover 415 may be made of an acetate material. The first medium cover 413 may be made of a paper material. The second medium cover 415 may be made of a paper material. At least one of the first medium cover 413 and the second medium cover 415 may be made of a paper material to be crumpled with wrinkles, and a plurality of gaps may be formed between the wrinkles to allow air to flow therethrough. Each of the gaps may be smaller than each of the granules of the medium 411. A length L1 of the first medium cover 413 may be less than the length L2 of the medium 411. A length L3 of the second medium cover 415 may be less than the length L2 of the medium 411. The length L1 of the first medium cover 413 may be 7 mm. The length L2 of the second medium cover 415 may be 7 mm.

Accordingly, each of the granules of the medium 411 may be prevented from being separated from the medium portion 410 and the stick 40.

The cooling portion 420 may have a cylindrical shape. The cooling portion 420 may have a hollow shape. The cooling portion 420 may be disposed between the medium portion 410 and the filter portion 430. The cooling portion 420 may be disposed between the second medium cover 415 and the filter portion 430. The cooling portion 420 may be formed in the shape of a tube that surrounds a cooling path 424 formed therein. The cooling portion 420 may be thicker than the wrapper 440. The cooling portion 420 may be made of a paper material thicker than that of the wrapper 440. A length L4 of the cooling portion 420 may be equal or similar to the length L2 of the medium 411. The length L4, which is the length of the cooling portion 420 and the cooling path 424, may be 10 mm. When the stick 40 is inserted into the aerosol generating device 10, at least a portion of the cooling portion 420 may be exposed to an outside of the aerosol generating device 10.

Accordingly, the cooling portion 420 may support the medium portion 410 and the filter portion 430, and may achieve the rigidity of the stick 40. In addition, the cooling portion 420 may support the wrapper 440 between the medium portion 410 and the filter portion 430, and may provide a portion to which the wrapper 440 is adhered. In addition, heated air and aerosol may be cooled while passing through the cooling path 424 in the cooling portion 420.

The filter portion 430 may be configured as a filter made of an acetate material. The filter portion 430 may be disposed at another end of the stick 40. When the stick 40 is inserted into the aerosol generating device 10, the filter portion 430 may be exposed to the outside of the aerosol generating device 10. A user may inhale air while holding the filter portion 430 in his or her mouth. A length L5 of the filter portion 430 may be 14 mm.

The wrapper 440 may wrap or surround the medium portion 410, the cooling portion 420, and the filter portion 430. The wrapper 440 may define an outer appearance of the stick 40. The wrapper 440 may be made of a paper material. An adhesive portion 441 may be formed along one edge of the wrapper 440. The wrapper 440 may surround the medium portion 410, the cooling portion 420 and the filter portion 430, and the adhesive portion 441 formed along the one edge of the wrapper 440 and another edge of the wrapper 440 may be adhered to each other. The wrapper 440 may surround the medium portion 410, the cooling portion 420, and the filter portion 430, but may not cover one end and another end of the stick 40.

Accordingly, the wrapper 440 may fix the medium portion 410, the cooling portion 420, and the filter portion 430, and may prevent these components from being separated from the stick 40.

A first thin film 443 may be disposed at a position corresponding to the first medium cover 413. The first thin film 443 may be disposed between the wrapper 440 and the first medium cover 413, or may be disposed outside the wrapper 440. The first thin film 443 may surround the first medium cover 413. The first thin film 443 may be made of a metal material. The first thin film 443 may be made of an aluminum material. The first thin film 443 may be in close contact with or coated on the wrapper 440.

A second thin film 445 may be disposed at a position corresponding to the second medium cover 415. The second thin film 445 may be disposed between the wrapper 440 and the second medium cover 415, or may be disposed outside the wrapper 440. The second thin film 445 may be made of a metal material. The second thin film 445 may be made of an aluminum material. The second thin film 445 may be in close contact with or coated on the wrapper 440.

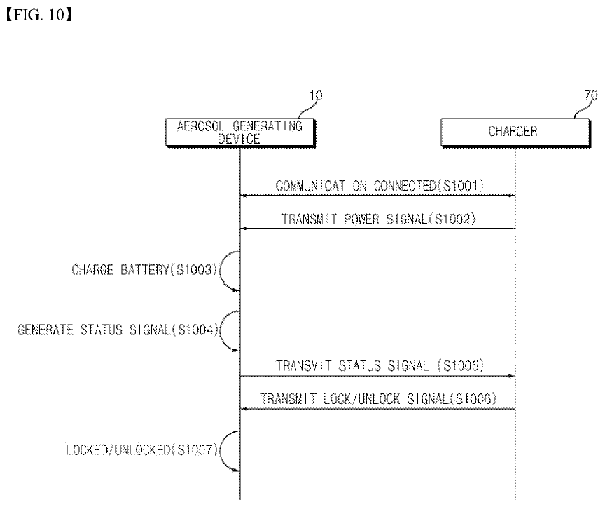

FIG. 8 is a view illustrating an aerosol generating system according to an embodiment of the present disclosure.

Referring to FIG. 8, an aerosol generating system 1 may include an aerosol generating device 10 and a charger 70.

The aerosol generating device 10 may include a communication interface 11, an input/output interface 12, a heater 131, a battery 16, and/or a controller 17. Since descriptions of the components of the aerosol generating device 10 overlap the descriptions of the components described above with reference to FIG. 1, detailed descriptions thereof will be omitted.

The charger 70 may be communicatively connected to the aerosol generating device 10. For example, the charger 70 may be communicatively connected to the aerosol generating device 10 using wireless communication. As the charger 70 is connected to the aerosol generating device 10 via wireless communication, a power signal may be transmitted to the aerosol generating device 10, and a data signal may be transmitted and received to and from the aerosol generating device 10.

The charger 70 may supply power to the aerosol generating device 10 using a known technology such as a magnetic induction method, a magnetic resonance method, an electromagnetic wave method, or the like. For example, the charger 70 may be in the form of a pad, and wireless charging may be started by placing the aerosol generating device 10 on the pad. As the pad of the charger 70 has a built-in primary coil, and the aerosol generating device 10 has a built-in secondary coil and a wireless charging circuit, power may be supplied to the aerosol generating device 10 from the charger 70 through mutual induced electromotive force. The supplied power may charge the battery 16 of the aerosol generating device 10.

Although not shown in the drawing, the aerosol generating system 1 may further include an external device 80.

The external device 80 may be communicatively connected to the charger 70. For example, the external device 80 may be communicatively connected to the charger 70 using wired/wireless communication.

The external device 80 may transmit user age authentication completion information to the charger 70.

The external device 80 is not particularly limited, and may be any of devices capable of transmitting user age authentication completion information to the charger 70 such as a desktop computer, a laptop computer, a smartphone, a tablet PC, a server computer, or the like.

The external device 80 may include at least one of an external server, a computing device provided in a store (or shop), and a user terminal.

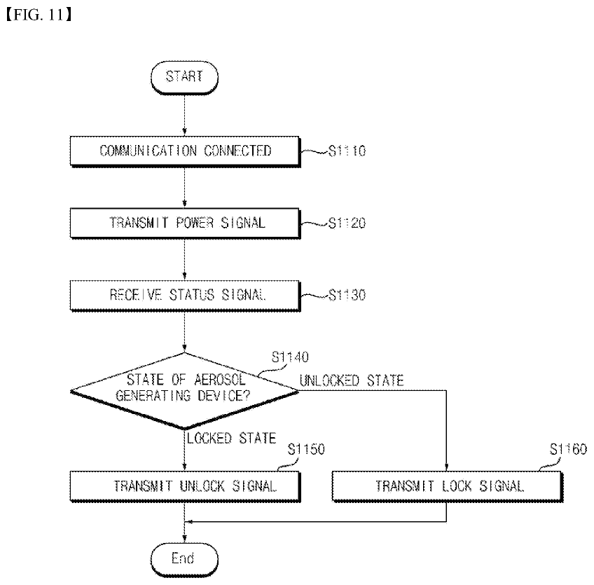

FIG. 9 is a block diagram of a charger according to an embodiment of the present disclosure.

Referring to FIG. 9, the charger 70 may be a device capable of supplying power to the outside.

The charger 70 may include a communication interface 710, a memory 720, an input/output interface 730, and a controller 740.

The communication interface 710 may include at least one communication module for communication with the aerosol generating device 10 and/or a network. For example, the communication interface 11 may include a communication module for wireless communication such as Wireless Fidelity (Wi-Fi), Bluetooth, Bluetooth low energy (BLE), Zigbee, or Near-Field Communication (NFC).

The communication interface 710 may include a transmitter 711 and a receiver 712. The transmitter 711 may transmit a signal to the aerosol generating device 10 and/or a network. The receiver 712 may receive a signal from the aerosol generating device 10 and/or the network. The signal transmitted and received through the transmitter 711 and the receiver 712 may be a data signal and/or a power signal.

The charger 70 may transmit, through the transmitter 711, a power signal to the aerosol generating device 10, allowing power to be supplied to the aerosol generating device 10.

The memory 720 may include at least one non-volatile memory (e.g., a flash memory, a hard disk drive (HDD), or a solid-state drive (SSD)).

The memory 720 may store a program for processing and controlling each signal in the controller 740, and may store processed data and data to be processed. Herein, a program and an application may be interchangeably used when necessary.

The memory 720 may store a preset lock signal (a lock key) and an unlock signal (an unlock key) in relation to locking or unlocking the aerosol generating device 10. For example, the lock signal and the unlock signal may be keys each having a predetermined value preset by the manufacturer of the aerosol generating device 10.

The memory 720 may store a unique identifier for the aerosol generating device 10 and/or a unique identifier for the external device 80. For example, the unique identifier for the aerosol generating device 10 and/or the unique identifier for the external device 80 may include a media access control address, (MAC address), a serial number, International Mobile Equipment Identity (IMEI), etc.

The memory 720 may store authentication information for switching the mode of the charger 70. For example, the memory 720 may store password information for switching the mode of the charger 70.

The input/output interface 730 may include an input device 731 that receives a command from a user and/or an output device 732 that outputs information to the user. For example, the input device 731 may include a touch panel, a physical button, etc. For example, the output device 732 may include a display device for outputting visual information such as an LED or a display, and an audio device for outputting auditory information such as a speaker.

The controller 740 may control the overall operation of the charger 70. The controller 740 may be connected to each of the components included in the charger 70, and may transmit and/or receive a signal to and/or from each of the components, thereby controlling the overall operation of each of the components.

The controller 740 may include at least one processor, and may control the overall operation of the charger 70 by using the processor included therein. Here, the processor may be a general processor such as a central processing unit (CPU). Alternatively, the processor may be a dedicated device such as an ASIC or any of other hardware-based processors. Meanwhile, the controller 740 may be implemented in the form of a single chip including the memory 720.

FIG. 10 is a flowchart illustrating the operation of an aerosol generating system, according to an embodiment of the present disclosure.

Referring to FIG. 10, the aerosol generating device 10 may be communicatively connected to the charger 70 in operation S1001. For example, the aerosol generating device 10 and the charger 70 may be communicatively connected to each other using wireless communication. For example, when the aerosol generating device 10 is placed adjacent to the charger 70 or placed on a pad of the charger 70, the aerosol generating device 10 and the charger 70 may be communicatively connected to each other via wireless communication.

The charger 70 may transmit a power signal to the aerosol generating device 10 in operation S1002. The communication interface 710 of the charger 70, which is a second communication interface, may wirelessly transmit the power signal to the communication interface 11 of the aerosol generating device 10, which is a first communication interface. For example, the second communication interface 710 of the charger 70 may include a primary coil, and the first communication interface 11 of the aerosol generating device 10 may include a secondary coil, allowing a power signal to be wirelessly transmitted from the primary coil of the charger 70 to the secondary coil of the aerosol generating device 10.

The aerosol generating device 10 may charge the battery 16 in operation S1003. The aerosol generating device 10 may charge the battery 16 with the power signal wirelessly received from the charger 70 through the first communication interface 11. For example, the aerosol generating device 10 may convert, through a rectifier, a power signal transmitted through the first communication interface 11 to chargeable power. The aerosol generating device 10 may charge the battery 16 with the converted power.

Meanwhile, in relation to operations S1002 and S1003, the aerosol generating device 10 may detect various events occurring during the process of charging, and may check the charging state of the battery 16 to generate a feedback signal. The aerosol generating device 10 may transmit the feedback signal to the charger 70 through the first communication interface 11. The controller 740 of the charger 70 may recognize the charging state of the aerosol generating device 10 based on the received feedback signal, and may control a power signal transmitted through the second communication interface 710.

The aerosol generating device 10 may generate a status signal in operation S1004. The status signal may include information indicating whether the aerosol generating device 10 is in a locked state or an unlocked state. The aerosol generating device 10 may determine whether a current operating state is a locked state or an unlocked state, and may generate a status signal based on the current operating state.

Here, the locked state of the aerosol generating device 10 may be a state in which use of at least one of a preheating function or heating function for supplying power to the heater 131, an input/output function for controlling the operation of the output device or controlling the operation of the input device, and a cleaning function for cleaning a stick insertion space is restricted. The unlocked state of the aerosol generating device 10 may be a state in which a restriction on use of at least one of the preheating function or the heating function, the input/output function, and the cleaning function is lifted.

The aerosol generating device 10 may transmit the status signal to the charger 70 through the first communication interface 11 in operation S1005. For example, the aerosol generating device 10 may wirelessly transmit the status signal to the charger 70 through the secondary coil of the first communication interface 11.

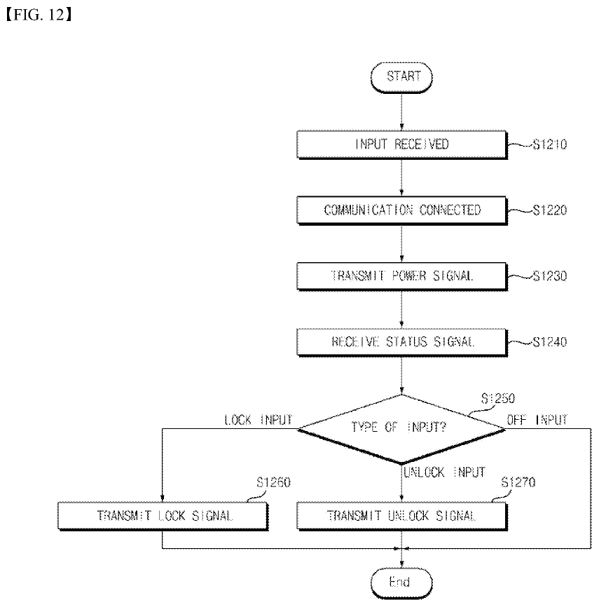

The charger 70 may transmit a lock signal or an unlock signal to the aerosol generating device 10 in operation S1006. The operation of transmitting the lock signal or the unlock signal by the charger 70 will be described later in detail with reference to FIGS. 11 and 12.

The aerosol generating device 10 may lock or unlock the aerosol generating device 10 based on the received signal in operation S1007.

For example, the aerosol generating device 10 may unlock the aerosol generating device 10 based on receiving an unlock signal from the charger 70 through the first communication interface 11. The aerosol generating device 10 may compare a signal received from the charger 70 with the lock key and the unlock key stored in the memory 14. When the received signal corresponds to the unlock key, the aerosol generating device 10 may determine that an unlock signal is received.

In response to receiving the unlock signal, the aerosol generating device 10 may lift a restriction on use of at least one of the preheating function or the heating function, the input/output function, and the cleaning function.

For example, the aerosol generating device 10 may lock the aerosol generating device 10 based on receiving a lock signal from the charger 70 through the first communication interface 11. The aerosol generating device 10 may compare a signal received from the charger 70 with the lock key and the unlock key stored in the memory 14. When the received signal corresponds to the lock key, the aerosol generating device 10 may determine that a lock signal is received.

In response to receiving the lock signal, the aerosol generating device 10 may restrict the use of at least one of the preheating function or the heating function, the input/output function, and the cleaning function.

Meanwhile, the status signal may include information indicating whether the aerosol generating device 10 is in shipping mode. The aerosol generating device 10 may determine whether a current operating state is a shipping mode state, and may generate a status signal indicating the shipping mode state when the current operating state is determined as the shipping mode. The aerosol generating device 10 may transmit status information to the charger 70.

Here, the shipping mode is a mode for minimizing power consumption of the aerosol generating device 10 by inactivating the hardware components in the aerosol generating device 10 except the controller while assembling and shipping the aerosol generating device 10. Most of the internal hardware components are inactivated in the shipping mode, which is a clear distinction from the lock mode that restricts the use of at least one function among a plurality of functions of the aerosol generating device 10.

The controller 17 of the aerosol generating device 10 may be programmed to be set to the shipping mode by an external input prior to shipping the aerosol generating device 10. Cancellation of the shipping mode may mean that the aerosol generating device 10 enters the unlock mode.

In this case, the charger 70 may transmit an unlock signal to the aerosol generating device 10 in operation S1006. When the aerosol generating device 10 is determined to be in the shipping mode based on the status information received from the aerosol generating device 10, the charger 70 may transmit the unlock signal to the aerosol generating device 10.

The aerosol generating device 10 may receive the unlock signal in operation S1007 to clear the shipping mode.

FIGS. 11 and 12 are flowcharts illustrating the operation of a charger, according to an embodiment of the present disclosure. A detailed description overlapping the description in FIG. 10 will be omitted.

Referring to FIG. 11, the charger 70 may be communicatively connected to the aerosol generating device 10 in operation S1110. For example, the aerosol generating device 10 and the charger 70 may be communicatively connected to each other using wireless communication.

The charger 70 may transmit a power signal to the aerosol generating device 10 in operation S1120. The second communication interface 710 of the charger 70 may wirelessly transmit the power signal to the first communication interface 11 of the aerosol generating device 10.

The charger 70 may receive a status signal from the aerosol generating device 10 in operation S1130.

The charger 70 may determine the state of the aerosol generating device 10 based on the received status signal in operation S1140. Based on the status signal, the charger 70 may determine whether the aerosol generating device 10 is currently in a locked state or an unlocked state.

When the aerosol generating device 10 is determined to be in the locked state, the charger 70 may transmit an unlock signal to the aerosol generating device 10 in operation S1150.

When the aerosol generating device 10 is determined to be in the unlocked state, the charger 70 may transmit a lock signal to the aerosol generating device 10 in operation S1160.

Meanwhile, prior to the communication connection operation of the charger 70 (operation S1110), age authentication of a user may be performed. The age authentication of the user refers to a procedure for verifying that the age of the user is greater than or equal to a certain age.

For example, age authentication of the user may be done by checking an ID card of the user by a person in charge of a store that sells the aerosol generating device 10. Here, the charger 70 may be a charger provided in the store. Once the age of the user is verified by the person in charge of the store, the aerosol generating device 10 and the charger 70 may be communicatively connected to each other. As the aerosol generating device 10 and the charger 70 are communicatively connected to each other, operations S1120 to S1160 may be performed.

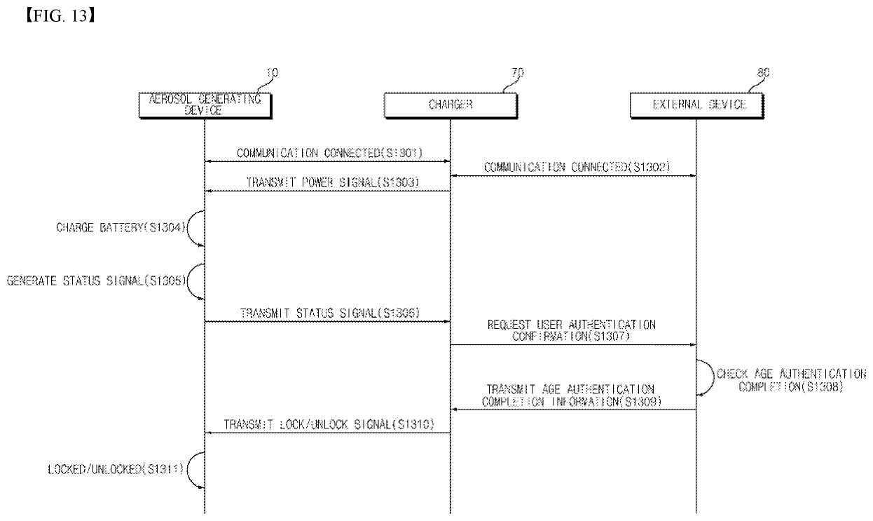

For example, age authentication of the user may be performed through the charger 70 and the external device 80. Age authentication and/or age authentication confirmation using the charger 70 and the external device 80 will be described later in detail with reference to FIG. 13.

Meanwhile, when the aerosol generating device 10 is determined to be in a shipping mode state in operation S1140, the charger 70 may transmit an unlock signal to the aerosol generating device 10 in operation S1150.

Referring to FIG. 12, the charger 70 may receive a user input in operation S1210. The charger 70 may receive one of a lock input, an unlock input, and an OFF input through the input device 731. For example, the input device 731 may include each of a lock input button, an unlock input button, and an OFF input button. For example, the input device 731 may include one button, and the lock input, the unlock input, and the OFF input may be identified according to the number of times and/or a duration of pressing the corresponding button. For example, the input device 731 may include a touch panel, and the lock input, the unlock input, and the OFF input may be identified based on an input of the touch panel.

The charger 70 may be communicatively connected to the aerosol generating device 10 in operation S1220. For example, the aerosol generating device 10 and the charger 70 may be communicatively connected to each other using wireless communication.

The charger 70 may transmit a power signal to the aerosol generating device 10 in operation S1230. The second communication interface 710 of the charger 70 may wirelessly transmit the power signal to the first communication interface 11 of the aerosol generating device 10.

The charger 70 may receive a status signal from the aerosol generating device 10 in operation S1240.

The charger 70 may determine a type of an input through the input device 731 in operation S1250. The charger 70 may determine which input, among the lock input, the unlock input, and the OFF input, corresponds to the input.

The charger 70 may switch the operation mode of the charger 70 to one of a lock operation mode, an unlock operation mode, and an OFF operation mode based on a received input. Here, the lock operation mode may be a mode in which the charger 70 transmits a lock signal to the aerosol generating device 10, the unlock operation mode may be a mode in which the charger 70 transmits an unlock signal to the aerosol generating device 10, and the OFF operation mode may be a mode in which the charger 70 does not transmit a lock signal and/or an unlock signal to the aerosol generating device 10.

The charger 70 may control such that the charger 70 is operated in the lock operation mode based on receiving the lock input. The charger 70 may control such that the charger 70 is operated in the unlock operation mode based on receiving the unlock input. The charger 70 may control such that the charger 70 is operated in the OFF operation mode based on receiving the OFF input.

The charger 70 may perform the operation of locking and wireless charging the aerosol generating device 10 in the lock operation mode, may perform the operation of unlocking and wireless charging the aerosol generating device 10 in the unlock operation mode, and may perform the operation of wirelessly charging the aerosol generating device 10 in the OFF operation mode.

In response to receiving a lock input through the input device 731, the charger 70 may transmit a lock signal to the aerosol generating device 10 in operation S1260. The charger 70 may transmit the lock signal to the aerosol generating device 10 in the lock operation mode.

In response to receiving an unlock input through the input device 731, the charger 70 may transmit an unlock signal to the aerosol generating device 10 in operation S1270. The charger 70 may transmit the unlock signal to the aerosol generating device 10 in the unlock operation mode.

In response to receiving an OFF input through the input device 73, the charger 70 may not transmit a lock signal and/or an unlock signal to the aerosol generating device 10 in the OFF operation mode. When the OFF input is received through the input device 731, the charger 70 may perform only a function of wirelessly charging the aerosol generating device 10.

Meanwhile, in operation S1210, when a lock input or an unlock input is received through the input device 731, the charger 70 may further perform the authentication operation. For example, when a lock input or an unlock input is received, the charger 70 may output, through the output device 732, information requesting a password input. Based on the password being input through the input device 731, the charger 70 may compare the entered password with information stored in the memory 720. When the entered password is determined to correspond to the stored information, the charger 70 may switch the operation mode of the charger 70.

Meanwhile, prior to the communication connection operation of the charger 70 (operation S1220), age authentication of a user may be performed.

For example, age authentication of the user may be done by checking an ID card of the user by a person in charge of a store that sells the aerosol generating device 10. For example, age authentication of the user may be performed through the charger 70 and the external device 80.

FIG. 13 is a flowchart illustrating the operation of an aerosol generating system according to another embodiment of the present disclosure. A detailed description overlapping the description in FIG. 10 will be omitted.

Referring to FIG. 13, an aerosol generating system 1 may include an aerosol generating device 10, a charger 70, and an external device 80.

The aerosol generating device 10 may be communicatively connected to the charger 70 in operation S1301.

The charger 70 may be communicatively connected to the external device 80 in operation S1302. For example, the charger 70 and the external device 80 may be communicatively connected to each other using wired/wireless communication.

The charger 70 may transmit a power signal to the aerosol generating device 10 in operation S1303.

The aerosol generating device 10 may charge a battery 16 in operation S1304. The aerosol generating device 10 may charge the battery 16 with a power signal wirelessly received from the charger 70.

The aerosol generating device 10 may generate a status signal in operation S1305. The status signal may include information indicating whether the aerosol generating device 10 is in a locked state or an unlocked state.

The aerosol generating device 10 may transmit the status signal to the charger 70 through a first communication interface 11 in operation S1306.

The charger 70 may request user authentication confirmation to the external device 80 in operation S1307. For example, the charger 10 may transmit an authentication confirmation request signal for requesting confirmation on whether user age authentication is completed to the external device 80. The authentication confirmation request signal may include at least one of an identifier of the aerosol generating device 10 and an identifier of the charger 70.

The external device 80 may check whether user age authentication is completed in operation S1308. The external device 80 may include at least one of an external server, a computing device provided in a store, and a user terminal.

For example, the external device 80 may be a computing device provided in a store. A user may proceed with user authentication through a computing device provided in a store that sells the aerosol generating device 10. The computing device may output an input window through an application or a program, and may obtain data corresponding to the user through the input window. The computing device may acquire an image of an ID card (a resident registration card, a driver's license, a passport, etc.) of the user through a camera or a scanner provided in the computing device, thereby obtaining at least one of a birthday, an age of the user, and a unique number representing the user.

The computing device may determine that the age of the user is greater than or equal to a certain age based on the acquired user information.

For example, the external device 80 may be a user terminal. The user may perform user authentication through the user terminal. The user terminal may output an input window through an application or a program, and may obtain data corresponding to the user through the input window. The user terminal may acquire an image of an ID card of the user through a camera or a scanner provided in the user terminal, thereby obtaining at least one of a birthday, an age of the user, and a unique number representing the user.

The user terminal may determine that the age of the user is greater than or equal to a certain age based on the acquired user information.

For example, the external device 80 may be an external server. The external server may receive data corresponding to the user from a user terminal or a computing device provided in a store. Based on the acquired user information, the external server may determine that the age of the user is greater than or equal to a certain age.

Based on the user age being verified, the external device 80 may generate user age authentication completion information to transmit the information to the charger 70 in operation S1309. The charger 70 may receive the user age authentication completion information (adult authentication completion information) from the external device 80.

The charger 70 may transmit a lock signal or an unlock signal to the aerosol generating device 10 in operation S1310.

The aerosol generating device 10 may lock or unlock the aerosol generating device 10 based on a received signal in operation S1311.

Meanwhile, the operation S1302 may be performed regardless of the operations S1303 to S1306. After the charger 70 is communicatively connected to the aerosol generating device 10 (after the operation S1301), the charger 70 may be communicatively connected to the external device 80 before or after receiving a status signal from the aerosol generating device 10.

As described above, according to at least one of the embodiments of the present disclosure, an aerosol generating device may be locked or unlocked through wireless charging communication.

According to at least one of the embodiments of the present disclosure, the shipping mode may be cleared through wireless charging communication even when an aerosol generating device is in a packaged state.

According to at least one of the embodiments of the present disclosure, a third party or a minor who does not have access to an aerosol generating device may be restricted from using the aerosol generating device.

Referring to FIGS. 1 to 13, an aerosol generating system 1 according to one aspect of the present disclosure may include an aerosol generating device 10 and a charger 70. The aerosol generating device 10 may include: a first communication interface 11; a battery 16; and a first controller 17. The first controller 17 may be configured to: perform control to charge the battery 16 based on wirelessly receiving a power signal from the charger 70 through the first communication interface 11; determine a state of the aerosol generating device 10 comprising a locked state or an unlocked state and generate a status signal corresponding to the state of the aerosol generating device 10; transmit, based on initiation of charging of the battery 16, the status signal to the charger 70 through the first communication interface 11; and change the aerosol generating device 10 to the unlocked state based on receiving an unlock signal from the charger 70 through the first communication interface 11.

According to another aspect of the present disclosure, the first controller 17 may be configured to change the aerosol generating device 10 to the locked state based on receiving a lock signal from the charger 70 through the first communication interface 11.

According to another aspect of the present disclosure, the charger 70 may include: a second communication interface 710; and a second controller 740. The second controller 740 may be configured to: perform control to wirelessly transmit a power signal to the aerosol generating device 10 through the second communication interface 710; receive the status signal from the aerosol generating device 10 through the second communication interface 710 and determine the state of the aerosol generating device 10 based on the status signal; transmit, based on the state being the locked state, the unlock signal to the aerosol generating device 10 through the second communication interface 710; and transmit, based on the state being the unlocked state, the lock signal to the aerosol generating device 10 through the second communication interface 710.

According to another aspect of the present disclosure, the second controller 740 may be configured to: receive user age authentication completion information from an external device wherein the unlock signal is transmitted to the aerosol generating device 10 through the second communication interface 710 based on the state being the locked state and further based on receiving the user age authentication completion information.

According to another aspect of the present disclosure, the charger 70 may include a second communication interface 710, a second controller 740 and a second input/output interface 730. The second controller 740 may be configured to: receive, through the second input/output interface 730, one of a lock input, an unlock input, and an OFF input; receive the status signal from the aerosol generating device 10 through the second communication interface 710; transmit the lock signal to the aerosol generating device 10 based on receiving the lock input when the status signal is received; and transmit the unlock signal to the aerosol generating device 10 based on receiving the unlock input when the status signal is received.

According to another aspect of the present disclosure, the lock signal or the unlock signal are not transmitted based on receiving the OFF input when the status signal is received.

According to another aspect of the present disclosure, the first controller 17 may be configured to: determine that the aerosol generating device 10 is in a shipping mode state, wherein the status signal transmitted to the charger 70 corresponds to the shipping mode state; and clear the shipping mode state based on receiving the unlock signal from the charger 70 through the first communication interface 11.

According to another aspect of the present disclosure, the aerosol generating device 10 may further include a heater 131 to heat an aerosol generating substance; a first input/output interface 12. The locked state of the aerosol generating device 10 may be a state in which at least one of a heating function for supplying power to the heater 131 or an input/output function for controlling the first input/output interface 12 is restricted, and the unlocked state of the aerosol generating device 10 may be a state in which at least one of the heating function and the input/output function is not restricted.

According to another aspect of the present disclosure, the first communication interface 11 may receive the power signal using a first operating frequency band and may transmit the status signal using an operating frequency band the same as the first operating frequency band.

An aerosol generating device 10 according to one aspect of the present disclosure may include: a first communication interface 11 configured to communicate with a charger 70 of the aerosol generating device 10; a battery 16; and a controller 17 configured to: perform control to charge the battery 16 based on wirelessly receiving a power signal from the charger 70 through the first communication interface 11; determine a state of the aerosol generating device 10 comprising a locked state or an unlocked state and generate a status signal corresponding to the state of the aerosol generating device 10; transmit, based on initiation of charging of the battery 16, the status signal to the charger 70 through the first communication interface 11; and change the aerosol generating device 10 to the unlocked state based on receiving an unlock signal from the charger 70 through the first communication interface 11.

According to another aspect of the present disclosure, the controller 17 may be configured to change the aerosol generating device 10 to the unlocked state based on receiving a lock signal from the charger 70 through the first communication interface 11.

According to another aspect of the present disclosure, the lock signal may be received from the charger 70 based on a lock input received by the charger 70 via an input interface 730 of the charger 70; and the unlock signal is received from the charger 70 based on an unlock input received by the charger 70 via the input interface 730 of the charger 70, and neither the lock signal or the unlock signal are received based an OFF input received by the charger 70 via the input interface 730 of the charger 70.

According to another aspect of the present disclosure, the aerosol generating device 10 may further include a heater 131 to heat an aerosol generating substance; a first input/output interface 12. The locked state of the aerosol generating device 10 may be a state in which at least one of a heating function for supplying power to the heater 131 or an input/output function for controlling the first input/output interface 12 is restricted, and the unlocked state of the aerosol generating device 10 may be a state in which at least one of the heating function or the input/output function is restricted.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol generating system comprising:
an aerosol generating device; and
a charger,
wherein the aerosol generating device comprises:
a first communication interface;
a battery; and
a first controller configured to:
perform control to charge the battery based on wirelessly receiving a power signal from the charger through the first communication interface;
determine a state of the aerosol generating device comprising a locked state or an unlocked state and generate a status signal corresponding to the state of the aerosol generating device;
transmit, based on initiation of charging of the battery, the status signal to the charger through the first communication interface; and
change the aerosol generating device to the unlocked state based on receiving an unlock signal from the charger through the first communication interface.

2. The aerosol generating system of claim 1, wherein the first controller is configured to change the aerosol generating device to the locked state based on receiving a lock signal from the charger through the first communication interface.

3. The aerosol generating system of claim 2, wherein the charger comprises:
a second communication interface; and
a second controller configured to:
perform to wirelessly transmit a power signal to the aerosol generating device through the second communication interface;
receive the status signal from the aerosol generating device through the second communication interface and determine the state of the aerosol generating device based on the status signal;
transmit, based on the state being the locked state, the unlock signal to the aerosol generating device through the second communication interface; and
transmit, based on the state being the unlocked state, the lock signal to the aerosol generating device through the second communication interface.

4. The aerosol generating system of claim 3, wherein the second controller is further configured to:
receive user age authentication completion information from an external device
wherein the unlock signal is transmitted to the aerosol generating device through the second communication interface based on the state being the locked state and further based on receiving the user age authentication completion information.

5. The aerosol generating system of claim 2, wherein the charger comprises a second communication interface, a second controller and a second input/output interface, and
wherein the second controller is configured to:
receive, through the second input/output interface, one of a lock input, an unlock input, and an OFF input;
receive the status signal from the aerosol generating device through the second communication interface;
transmit the lock signal to the aerosol generating device based on receiving the lock input when the status signal is received; and
transmit the unlock signal to the aerosol generating device based on receiving the unlock input when the status signal is received.

6. The aerosol generating system of claim 5, wherein the lock signal or the unlock signal are not transmitted based on receiving the OFF input when the status signal is received.

7. The aerosol generating system of claim 1, wherein the first controller is further configured to:
determine that the aerosol generating device is in a shipping mode state, wherein the status signal transmitted to the charger corresponds to the shipping mode state; and
clear the shipping mode state based on receiving the unlock signal from the charger through the first communication interface.

8. The aerosol generating system of claim 1, wherein the aerosol generating device further comprises:
a heater configured to heat an aerosol generating substance; and
a first input/output interface,
wherein the locked state of the aerosol generating device is a state in which at least one of a heating function for supplying power to the heater or an input/output function for controlling the first input/output interface is restricted, and
wherein the unlocked state of the aerosol generating device is a state in which at least one of the heating function or the input/output function is not restricted.

9. The aerosol generating system of claim 1, wherein the first communication interface is configured to receive the power signal using a first operating frequency band and transmit the status signal using an operating frequency band the same as the first operating frequency band.

10. An aerosol generating device comprising:
a first communication interface configured to communicate with a charger for the aerosol generating device;
a battery; and
a controller configured to:
perform control to charge the battery based on wirelessly receiving a power signal from the charger through the first communication interface;
determine a state of the aerosol generating device comprising a locked state or an unlocked state and generate a status signal corresponding to the state of the aerosol generating device;
transmit, based on initiation of charging of the battery, the status signal to the charger through the first communication interface; and
change the aerosol generating device to the unlocked state based on receiving an unlock signal from the charger through the first communication interface.

11. The aerosol generating device of claim 10, wherein the controller is configured to change the aerosol generating device to the locked state based on receiving a lock signal from the charger through the first communication interface.

12. The aerosol generating device of claim 10,
wherein the lock signal is received from the charger based on a lock input received by the charger via an input interface of the charger;
wherein the unlock signal is received from the charger based on an unlock input received by the charger via the input interface of the charger, and
wherein neither the lock signal or the unlock signal are received based an OFF input received by the charger via the input interface of the charger.

13. The aerosol generating device of claim 10, further comprising:
a heater configured to heat an aerosol generating substance; and
a first input/output interface,
wherein the locked state of the aerosol generating device is a state in which at least one of a heating function for supplying power to the heater or an input/output function for controlling the first input/output interface is restricted, and
wherein the unlocked state of the aerosol generating device is a state in which at least one of the heating function or the input/output function is not restricted.
